(19) United States
(12) Patent Application Publication
(10) Pub. No.: US 2021/0097913 A1
(43) Pub. Date: Apr. 1, 2021

(54) DE-MUX DRIVING ARCHITECTURE, CIRCULAR DISPLAY PANEL AND SMART WATCH

(71) Applicant: Wuhan China Star Optoelectronics Technology Co., Ltd., Wuhan, (CN)

(72) Inventor: Zhenzhou Xing, Wuhan (CN)

(21) Appl. No.: 16/097,832

(22) PCT Filed: Sep. 12, 2018
(86) PCT No.: PCT/CN2018/105338

§ 371 Date: Oct. 30, 2018

(30) Foreign Application Priority Data
Apr. 24, 2018 (CN) 201810373374.6

(51) Int. Cl. G09G 3/20; G04G 9/00

(52) U.S. Cl. CPC G09G 3/20; G04G 9/007; G09G 2310/0286; G09G 2310/0297; G09G 2310/0275; G09G 2310/08

(57) ABSTRACT

The present invention relates to a De-mux driving architecture, a circular display panel and a smart watch. The De-mux driving architecture includes a data driving chip, a multiplexing unit, and a shift register. Wherein each multiplexing unit includes a data input terminal for connecting a corresponding data line derived from the data driving chip, N control terminals used for respectively inputting corresponding N control signals from the shift register, and the N data output terminals used for respectively outputting N channels of data. Wherein each shift register includes a first input terminal for inputting a start signal, a second input terminal for inputting a clock signal, and N output terminals for respectively outputting N control signals to N control terminals of the multiplexing unit. The present invention can realize a larger screen occupation ratio, and beneficial for realizing the extremely narrow design of the lower border of the panel.

### FIELD OF THE INVENTION

The present invention relates to a display technology field, and more particularly to a De-mux driving architecture, a circular display panel and a smart watch.

### BACKGROUND OF THE INVENTION

Currently, with the rapid development and popularization of Internet technology, wearable devices are increasingly entering people's daily lives, and the performance of smart watch is particularly prominent. The traditional watch only plays a role of timing and decoration. However, emerging smart watches, such as iwatch and Huawei watch, not only have traditional watch functions, but also enable voice calls, text messages, map navigation, and other functions. The realization cannot be separated from the smart watch equipped with a circular liquid crystal panel. With reference to FIG. 1, which is a schematic diagram of a conventional smart watch.

A conventional circular panel mostly adopts a 1:6 De-mux driving architecture design, as shown in FIG. 2A, which is a schematic diagram of a conventional 1:6 De-mux driving architecture. The driving chip outputs data signals through a data line (Source line) and multiplexes them through the 1:6 De-mux architecture. That is, one data line corresponds to six mux signals, and the mux1/mux2/mux3/mux4/mux5/mux6 signals are turned on one by one in a time-division multiplexing manner to charges the pixels. However, since multiple mux signals are used, the screen occupation ratio of the circular panel is greatly reduced, as shown in FIG. 2B, which is a schematic diagram of the screen occupation ratio of the circular panel of the conventional 1:6 De-mux driving architecture.

### SUMMARY OF THE INVENTION

Accordingly, an object of the present invention is to provide a De-mux driving architecture, a circular display panel, and a smart watch, which can reduce the number of data lines and reduce the area occupied by the De-mux driving architecture.

In order to realize the above purpose, the present invention provides a De-mux driving architecture, comprising: a data driving chip; a multiplexing unit; and a shift register; wherein each multiplexing unit includes a data input terminal for connecting a corresponding data line derived from the data driving chip, N control terminals used for respectively inputting corresponding N control signals from the shift register, and the N data output terminals used for respectively outputting N channels of data; and wherein each shift register includes a first input terminal for inputting a start signal, a second input terminal for inputting a clock signal, and N output terminals for respectively outputting N control signals to N control terminals of the multiplexing unit.

Wherein the shift register includes N cascaded shift register units, the N shift register units respectively outputs corresponding N control signals to N control terminals of the multiplexing unit from N output terminals of the shift register.

Wherein the clock signal controls a time period of the control signal outputted by each of the shift register units in order to control turned-on times of the N control terminals of the multiplexing unit.

Wherein the multiplexing unit includes N switching transistors, the data input terminals of the multiplexing unit are connected together by input terminals of the switching transistors, and the control terminals of the N switching transistors respectively serve as N control terminals of the multiplexing unit, the output terminals of the N switching transistors respectively serve as N data output terminals of the multiplex unit.

Wherein each of the N switching transistors is an NMOS.

Wherein the data driving chip outputs the start signal and the clock signal.

Wherein N equal to six.

Wherein the multiplexing unit and shift register corresponding to each data line operate synchronously after obtaining the start signal and the clock signal.

The present invention also provides a circular display panel, comprising the De-mux driving architecture as claimed in anyone of the above.

The present invention also provides a smart watch, comprising the above circular display panel.

In summary, the De-mux driving architecture, the circular display panel and the smart watch of the present invention can realize a larger screen occupation ratio of the circular panel; beneficial for realizing the extremely narrow design of the lower border of the panel; and reducing the design complexity of the lower border of the panel.

### BRIEF DESCRIPTION OF THE DRAWINGS

The technical solutions and other beneficial effects of the present invention will be apparent from the following detailed description of specific embodiments of the present invention with reference to the accompanying figures.

In the figures,

FIG. 1 is a schematic structural diagram of a conventional smart watch;

FIG. 2A is a schematic diagram of a conventional 1:6 De-mux driving architecture;

FIG. 2B is a schematic diagram of the screen occupation ratio of the circular panel of the conventional 1:6 De-mux driving architecture;

FIG. 3 is a schematic diagram of the screen occupation ratio of the circular panel of the 1:N De-mux driving architecture according to the present invention;

FIG. 4 is a schematic structural diagram of a preferred embodiment of a De-mux driving architecture according to the present invention;

FIG. 5 is a schematic diagram of an operation principle of a shift register of a De-mux driving architecture according to the present invention;

FIG. 6 is a schematic diagram of a conventional 1:N De-mux driving architecture; and

FIG. 7 is a schematic diagram of a preferred embodiment of 1:N De-mux driving architecture according to the present invention.

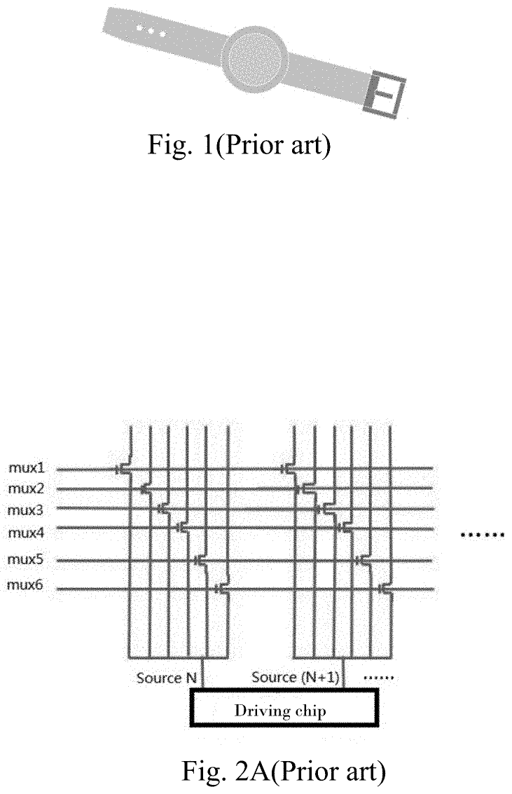

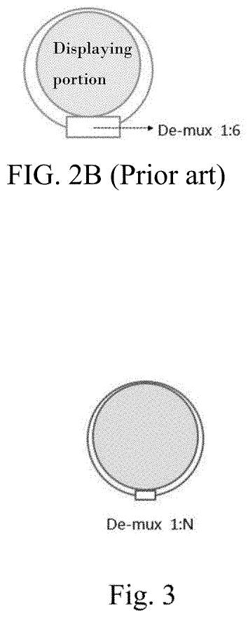

### DETAILED DESCRIPTION OF THE PREFERRED EMBODIMENT

With reference to FIG. 3, which is a diagram of a screen occupation ratio of the circular panel of a De-mux (demultiplexing) driving architecture according to the present invention, the present invention provides a novel 1:N De-mux architecture for the circular display panel, which reduces the number of data lines while reducing the area occupied by the De-mux architecture, and ultimately achieves a larger screen occupation ratio of the circular display panel

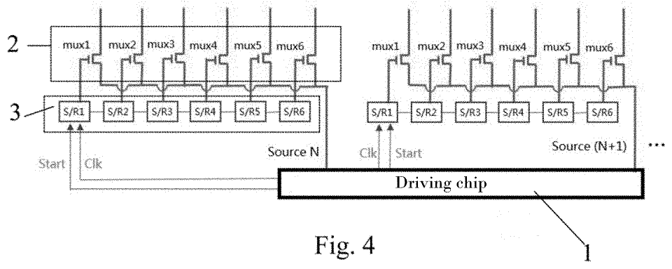

With reference to FIG. 4, which is a schematic structural diagram of a De-mux driving architecture according to a preferred embodiment of the present invention. The De-mux driving architecture mainly includes: a data driving chip 1, a multiplexing unit 2, and a shift register 3.

Each multiplexing unit 2 includes a data input terminal for connecting a corresponding data line (for example, Source N) derived from the data driving chip 1; six control terminals used for respectively inputting corresponding six control signals from the shift register 3, and through a time-division multiplexing way to turn on mux1/mux2/mux3/mux4/mux5/mux6 signals one by one in order to charge pixels; and six data output terminals used for respectively outputting six channels of data, that is, mux1/mux2/mux3/mux4/mux5/mux6 signals.

Each shift register 3 includes a first input terminal for inputting a start signal “Start”, a second input terminal for inputting a clock signal “Clk”, and six output terminals for respectively outputting six control signals to six control terminals of the multiplexing unit 2. The start signal “Start” and the clock signal “Clk” can come from the data driving chip 1.

The shift register 3 includes six cascaded shift register units S/R1˜S/R6. The shift register units S/R1˜S/R6 respectively outputs corresponding six control signals to six control terminals of the multiplexing unit 2 from six output terminals of the shift register 3. The first-stage shift register unit S/R1 of the shift register 3 inputs the start signal “Start”.

The clock signal “Clk” controls a time period of the control signal outputted by each of the shift register units S/R1 to S/R6 in order to control a turned-on time of the six control terminals of the multiplexing unit 2. Through the time-division multiplexing way to turn on mux1/mux2/mux3/mux4/mux5/mux6 signals one by one in order to charge the pixels.

In this embodiment, the multiplexing unit 2 includes six switching transistors. The data input terminals of the multiplexing unit 2 are connected together by input terminals of the switching transistors, and the control terminals of the six switching transistors respectively serve as six control terminals of the multiplexing unit 2. The output terminals of the six switching transistors respectively serve as six data output terminals of the multiplex unit 2. Each of the six switching transistors can be an NMOS, with a gate electrode acting as the control terminal and a source and a drain acting as the input/output terminals.

In this preferred embodiment, the shift register (S/R) design is introduced in the 1:6 De-mux driving architecture, and only one row of the mux control unit is existed, so that the lower border of the panel can be greatly reduced, thereby improving the screen occupation ratio of the circular display panel.

Each data line corresponds to a group of the 1:6 De-mux unit (multiplexing unit 2 and shift register 3). The Start/Clk signal controls the operation of shift register 3, that is, sequentially turning on mux1/mux2/mux3/mux4/mux5/mux6 signals to charge the pixels through the S/R signals.

Since the entire panel needs to be charged during charging, the group of 1:6 De-mux unit (multiplexing unit 2 and shift register 3) corresponding to each data line need to be synchronized after obtaining the Start/Clk signal.

After one clock cycle, the shift register units S/R1˜S/R6 deliver a logic circuit of an input stage to an output stage of each of the shift register units S/R1˜S/R6.

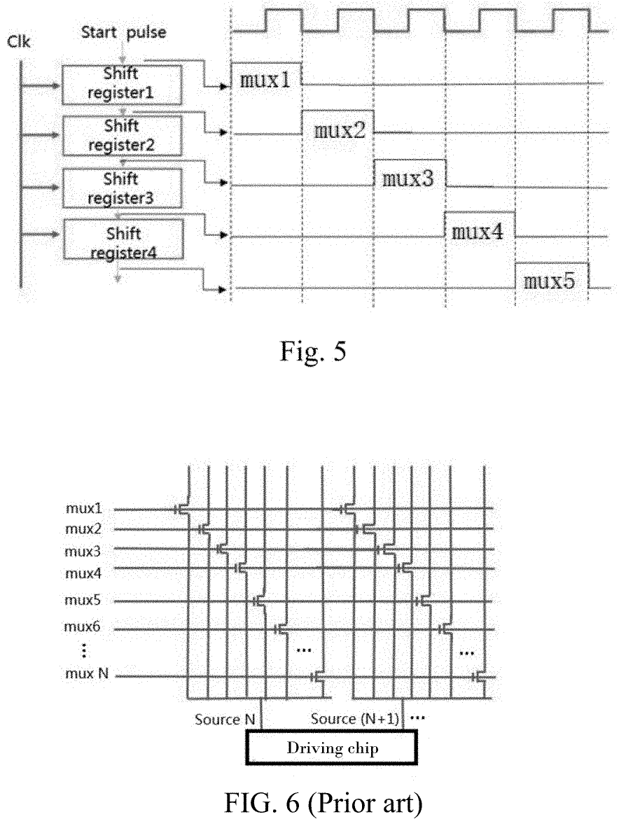

As shown in FIG. 5, which is a schematic diagram of a operation principle of a shift register of the De-mux driving architecture according to the present invention, a vertical start pulse signal is sent to a first stage of the shift register (shift register 1), then using the Clk clock signal in the vertical direction to control a time of an output state of each shift register unit so as to sequentially turn on mux1/mux2/mux3 . . . mux 6 signals.

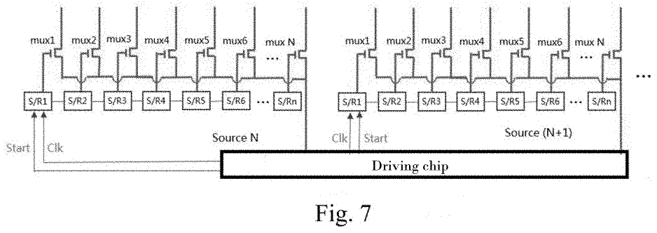

FIG. 6 is a schematic diagram of a conventional 1:N De-mux driving architecture. The driving chip outputs data signals through the data lines and through the 1:N De-mux architecture to perform a multiplexing. That is, one data line corresponds to N multiplexing signals, and the mux1/mux2/mux3/mux4/mux5/mux6 . . . muxN are turned on one by one in a time division multiplexing manner to charge the pixels.

FIG. 4 of the present invention is based on the existing 1:6 De-mux driving architecture, but as the increase of the carrier mobility, the present invention is not limited to 1:6 De-mux driving architecture, a 1:N De-mux architecture is also within the scope of the present invention. With reference to FIG. 7, which is a schematic diagram of a preferred embodiment a 1:N De-mux driving architecture according to the present invention, a shift register (shift register unit S/R1˜S/RN) design is introduced, and only one row of the mux control unit is provided. The lower border of the panel can be greatly reduced, thereby increasing the screen occupation ratio of the circular display panel.

In a preferred embodiment of the present invention, a circular display panel is also provided, including the above De-mux driving architecture.

The present invention also provides a smart watch including the above-mentioned circular display panel.

In summary, the De-mux driving architecture, the circular display panel and the smart watch of the present invention can realize a larger screen occupation ratio of the circular panel; beneficial for realizing the extremely narrow design of the lower border of the panel; and reducing the design complexity of the lower border of the panel.

The above embodiment does not constitute a limitation of the scope of protection of the present technology solution. Any modifications, equivalent replacements and improvements based on the spirit and principles of the above embodiments should also be included in the protection scope of the present technology solution.

What is claimed is:

1. A De-mux driving architecture, comprising:
a data driving chip;
a multiplexing unit; and
a shift register;
wherein each multiplexing unit includes a data input terminal for connecting a corresponding data line derived from the data driving chip, N control terminals used for respectively inputting corresponding N control signals from the shift register, and the N data output terminals used for respectively outputting N channels of data; and
wherein each shift register includes a first input terminal for inputting a start signal, a second input terminal for inputting a clock signal, and N output terminals for respectively outputting N control signals to N control terminals of the multiplexing unit.

2. The De-mux driving architecture according to claim 1, wherein the shift register includes N cascaded shift register units, the N shift register units respectively outputs corresponding N control signals to N control terminals of the multiplexing unit from N output terminals of the shift register.

3. The De-mux driving architecture according to claim 2, wherein the clock signal controls a time period of the control signal outputted by each of the shift register units in order to control turned-on times of the N control terminals of the multiplexing unit.

4. The De-mux driving architecture according to claim 1, wherein the multiplexing unit includes N switching transistors, the data input terminals of the multiplexing unit are connected together by input terminals of the switching transistors, and the control terminals of the N switching transistors respectively serve as N control terminals of the multiplexing unit, the output terminals of the N switching transistors respectively serve as N data output terminals of the multiplex unit.

5. The De-mux driving architecture according to claim 4, wherein each of the N switching transistors is an NMOS.

6. The De-mux driving architecture according to claim 1, wherein the data driving chip outputs the start signal and the clock signal.

7. The De-mux driving architecture according to claim 1, wherein N equal to six.

8. The De-mux driving architecture according to claim 1, wherein the multiplexing unit and shift register corresponding to each data line operate synchronously after obtaining the start signal and the clock signal.

9. A circular display panel, comprising the De-mux driving architecture as claimed in claim 1.

10. A smart watch, comprising the circular display panel as claimed in claim 9.
